(19) United States
(12) Patent Application Publication
(10) Pub. No.: US 2010/0278208 A1
(43) Pub. Date: Nov. 4, 2010

(54) FASTENING MEANS FOR TERMINALS FOR ELECTRICAL RESISTANCE ELEMENTS

(75) Inventor: Jan Andersson, Vasteras (SE)

Correspondence Address: DRINKER BIDDLE & REATH (DC), 1500 K STREET, N.W., SUITE 1100, WASHINGTON, DC, 20005-1209, US

(73) Assignee: SANDVIK INTELLECTUAL PROPERTY AB, SANDVIKEN (SE)

(21) Appl. No.: 12/746,089

(22) PCT Filed: Nov. 26, 2008
(86) PCT No.: PCT/SE2008/051351

§ 371 Date: Jul. 13, 2010

(30) Foreign Application Priority Data
Dec. 5, 2007 (SE) 0702701-4

(51) Int. Cl. H05B 3/66

(52) U.S. Cl. 373/128

(57) ABSTRACT

A suspension arrangement for terminals for electrical resistive elements, which terminals pass vertically through a body and are attached relative to the upper surface of the body, which terminals pass over into the hot zone of the resistive element in the form of a shank element, which extends downwards from the terminals, where one or several of the shanks of the hot zone is or are supported by hooks attached to the lower surface of the body. The suspension arrangement for each one of the terminals includes a first attachment attached relative to the upper surface of the body and a second attachment attached relative to the terminal. A spring arrangement passes between the first and the second attachment, which spring arrangement is arranged such that the second attachment is mobile in the vertical direction relative to the first attachment.

The present invention relates to a suspension arrangement for terminals for electrical resistive elements.

One type of electrical resistive elements is suspended vertically in a holder, in the form of a body, through which terminals pass. The element normally has several shanks, whereby the upper bend zones of the element are suspended in hot zone attachments in the form of hooks, which are attached to the holder. The terminals are furthermore attached at the upper surface of the holder in order in this way to bear the weight of the terminals. The element in its hot condition is unable to bear the weight of the terminals.

The hot zone, the hot zone attachments and the terminals all become longer when heated. The extension of the terminals between the respective holder of the terminals and the level of the upper part of the hot zone is greater than the extension of the hot zone attachments. This results in the weight of the terminals being transferred to the first hot zone shank, which results in a deformation of this shank taking place.

The reverse process takes place during cooling, i.e. the terminals shrink relatively more than the hot zone attachments. The shrinkage of the terminals leads to the complete element being lifted and resting on the _{two} terminal holders. There is no reduction in load for the hot zone in this condition.

During a subsequent heating operation, the hot zone is heated more rapidly than the terminals, whereby imbalance between the suspension points is evened out through deformation of the hot zone.

It will not be possible to control this sequence of events during cyclic variation in temperature, whereby deformation of the element system will escalate, resulting in the destruction of elements.

The present invention solves this problem.

The present invention thus relates to a suspension arrangement for terminals for electrical resistive elements, which terminals pass vertically through a body and are attached relative to the upper surface of the body, which terminals pass over into the hot zone of the resistive element in the form of a shank element, which extends downwards from the terminals, where one or several of the shanks of the hot zone is or are supported by hooks attached to the lower surface of the body, and it is characterised in that the suspension arrangement for each one of the terminals comprises a first attachment attached relative to the upper surface of the body and a second attachment attached relative to the terminal, and in that a spring arrangement passes between the first and the second attachment, which spring arrangement is arranged such that the second attachment is mobile in the vertical direction relative to the first attachment.

The invention is described in more detail below, partially in connection with an embodiment of the invention shown in the attached drawing, where

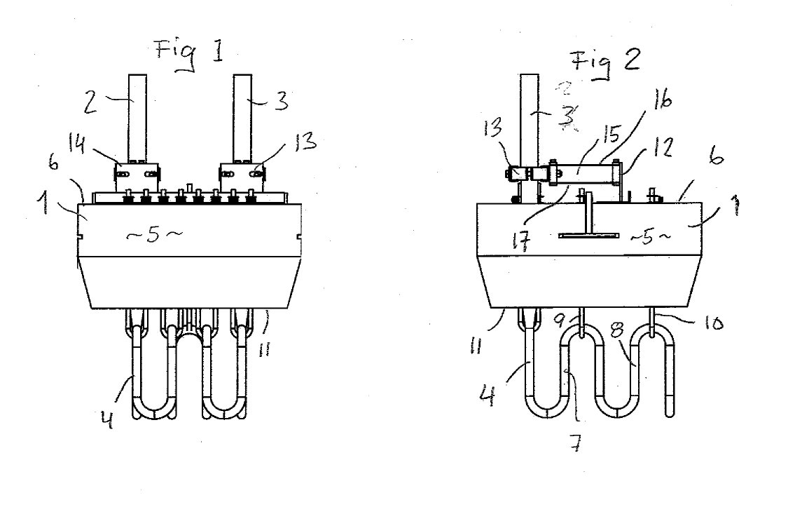

FIG. 1 shows a suspension arrangement according to the invention seen in a view from the front, and

FIG. 2 shows the suspension arrangement in FIG. 1 in a view from the side.

FIG. 1 shows a suspension arrangement 1 for terminals 2, 3 for electrical resistive elements 4. The terminals pass vertically through a body 5 and are attached relative to the upper surface 6 of the body 5. The terminals pass over into the hot zone of the resistive element 4 in the form of a shank element, which extends downwards from the terminals 2, 3. One or several of the shanks 7, 8 of the hot zone 4 is or are supported by hooks 9, 10 attached to the lower surface 11 of the body.

According to the invention, the suspension arrangement 1 comprises for each one of the terminals 2, 3 a first attachment 12 attached relative to the upper surface 6 of the body 5 and a second attachment 13, 14 attached relative to the terminals 2, 3 where a spring arrangement 15 passes between the first 12 attachment and the second 13, 14 attachment, which spring arrangement 15 is arranged such that the second attachment 13, 14 is mobile in the vertical direction relative to the first attachment 12.

The body with the terminals and the resistive element is arranged to be inserted into, for example, a hole in the roof of a furnace, such that the terminals protrude above the roof of the furnace and such that the hot zone of the resistive element is located in the furnace cavity.

According to one preferred embodiment, the spring arrangement 15 comprises a blade spring that is oriented essentially parallel with the upper surface 6 of the body 5.

According to a further preferred embodiment, the spring arrangement 15 comprises two blade springs 16, 17 that are arranged parallel to each other.

According to a highly significant embodiment, the spring arrangement 15 has an upwardly directed spring force that corresponds to at least the weight of the terminal 2, 3 and its electrical connections.

In this way, vertical movements in the terminals due to their extension and shrinking at different temperatures and due to movement of the hot zone will be allowed through the spring arrangement.

Thus, the problem described in the introduction will be avoided.

A number of embodiments have been described above. It is, however, obvious that the spring arrangement can be given another design without deviating from the innovative concept, which is that of suspending the terminals in a spring arrangement in order to allow vertical movement of the terminals.

The present invention, therefore, is not to be considered to be limited to the embodiments specified above but it can be varied within the scope specified by the attached patent claims.

1. A suspension arrangement for terminals for electrical resistive elements, which terminals pass vertically through a body and are attached relative to the upper surface of the body, which terminals pass over into the hot zone of the resistive element in the form of a shank element, which extends downwards from the terminals, where one or several of the shanks of the hot zone is or are supported by hooks attached to the lower surface of the body, wherein the suspension arrangement for each one of the terminals comprises a first attachment attached relative to the upper surface of the body and a second attachment attached relative to the terminal, and where a spring arrangement passes between the first and the second attachment, which spring arrangement is arranged such that the second attachment is mobile in the vertical direction relative to the first attachment.

2. A suspension arrangement according to claim 1, wherein the spring arrangement comprises a blade spring that is oriented essentially parallel with the upper surface of the body.

3. A suspension arrangement according to claim 1, wherein the spring arrangement comprises two blade springs that are arranged parallel with each other.

4. A suspension arrangement according to claim 1, wherein the spring arrangement has an upwardly directed spring force that corresponds to at least the weight of the terminals and their electrical connections.
